(19) United States
(12) Patent Application Publication
(10) Pub. No.: US 2011/0253954 A1
(43) Pub. Date: Oct. 20, 2011

(54) TRAILER HITCH JACK

(76) Inventor: WILLIAM OLEN FORTNER, Gillette, WY (US)

(21) Appl. No.: 13/086,626

(22) Filed: Apr. 14, 2011

Related U.S. Application Data
(60) Provisional application No. 61/324,404, filed on Apr. 15, 2010.

(51) Int. Cl. B66F 3/08; B66F 3/10

(52) U.S. Cl. 254/98

(57) ABSTRACT

A trailer hitch jack is disclosed. The trailer hitch jack may include a jack housing tube, an extender tube, a drop leg tube, and a hitch engagement tube projecting orthogonally from the jack housing tube. The jack housing tube, extender tube, and drop leg tube may be coupled to one another and configured to telescope upon operation of a hand crank.

### CROSS-REFERENCE TO RELATED APPLICATION

The present application claims the benefit of U.S. Provisional Application No. 61/324,404, filed Apr. 15 2010, which is incorporated herein by reference.

### BACKGROUND OF THE INVENTION

The present invention relates in general to a jacks, and more particularly to a trailer hitch jack.

Presently some utility vehicles do not provide a point at the rear of the vehicle where an engagement element of a jack may be placed for the purpose of lifting the rear end of the vehicle. Some known jacks may engage the frame of the vehicle typically around the side portions of the frame. However some vehicles may be damaged by use of a jack on their frame sides. Some other vehicles, such as those with a towing hitch typically located at the rear of the vehicle may in some cases, not include a convenient or sturdy spot on the frame to lift the vehicle.

As can be seen, there may be a need for a jack, which can securely engage the trailer hitch of a vehicle.

### SUMMARY OF THE INVENTION

In one aspect the present invention provides for a trailer hitch jack. The trailer hitch jack includes jack housing tube. A hitch engagement tube is welded orthogonal to the jack housing tube. The hitch engagement tube is configured to securely engage a hitch receiver of a vehicle. An extender tube is movably attached to the jack housing and is configured to telescope in and out of the jack housing tube. A drop leg tube has a first end. The drop leg is movably attached to the extender tube and it is configured to telescope from the extender tube. A base is coupled to the first end of the drop leg tube. A hand crank is coupled to jack housing tube is operable for moving the drop leg tube and raising the jack housing tube from the base.

These and other features, aspects and advantages of the present invention may be better understood with reference to the following drawings, description and claims.

### BRIEF DESCRIPTION OF THE DRAWINGS

FIG. 1 is an isometric view of a trailer hitch jack according to an embodiment of the present invention;

FIG. 2 is a detailed isometric view of the trailer hitch jack of FIG. 1;

FIG. 3 is a side view of the trailer hitch jack of FIG. 1;

FIG. 4 is a cross-section view of the trailer hitch jack along line 4-4 of FIG. 2;

FIG. 5 is a perspective view of a trailer hitch jack of FIG. 1 with a detachable swiveling foot; and

FIG. 6 is an exploded view of the trailer hitch jack of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a trailer hitch jack. A trailer hitch on some vehicles may be coupled to the vehicle frame. Towing/trailer hitches are typically attached to at least two points on the frame of the vehicle, therefore it could be used to provide a secure location for the engagement element of a jack.

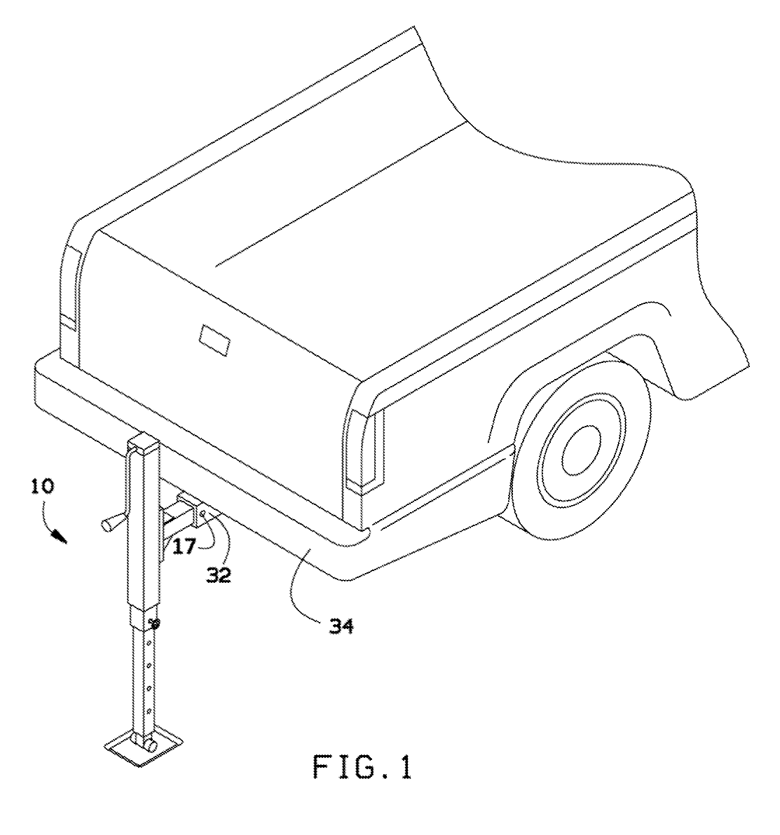

Referring now to the figures, FIG. 1 shows a trailer hitch jack 10 mounted to a hitch receiver 32 of a vehicle 34 according to exemplary embodiments of the present invention.

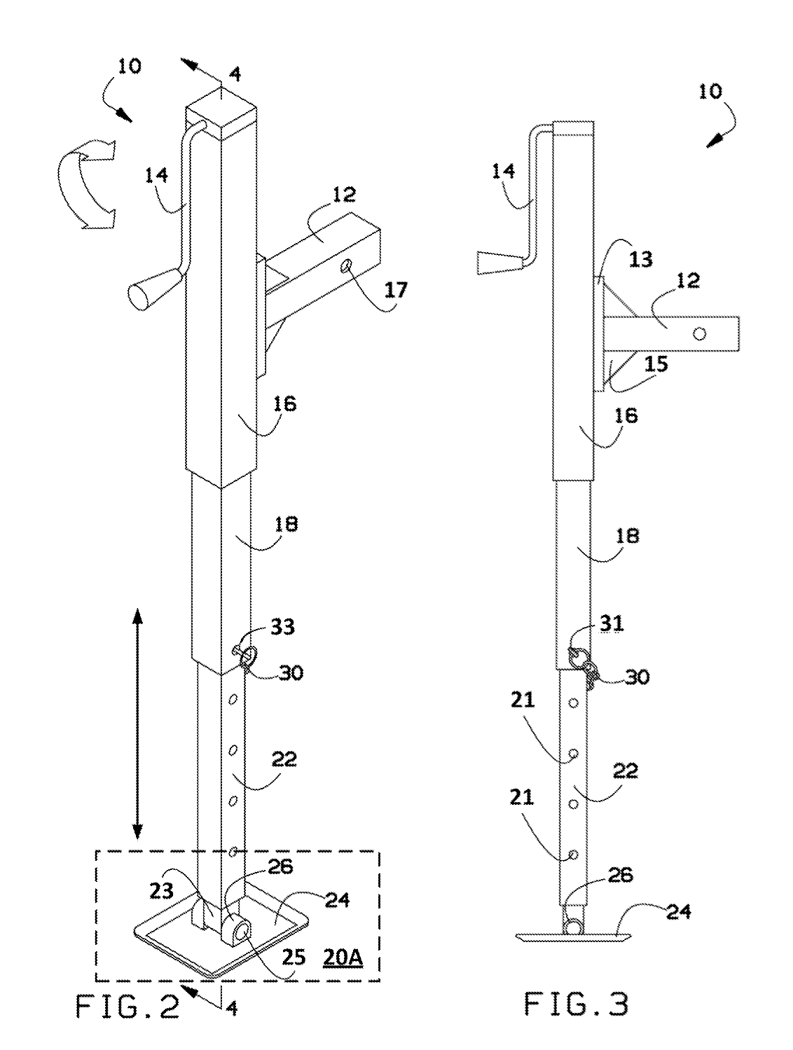

Referring now to FIGS. 2-4, different views of the trailer hitch jack 10 are shown. The trailer hitch jack 10 may include three telescoping vertically aligned tubes: a drop leg tube 22, an extender tube 18 and a jack housing tube 16. The tubes 16, 18 and 22 may be made from a square tubing material and coupled to one another so that the tube 18 telescopes out from the tube 16 and the tube 22 telescopes out from the tube 18. The drop leg tube 22 may include a plurality of adjustment holes 21. In one exemplary embodiment, he adjustment holes 21 may be placed evenly about 2″ apart. The extender tube 18 may include a securing hole 33 aligned with the adjustment holes 21. The hitch jack 10 may include a hitch engagement tube 12 that may project orthogonally from the jack housing tube 16. The hitch engagement tube 12 be welded perpendicular to a bearing plate 13 coupled to the jack housing tube 16 to form a cantilever. A 1 ¾″ gusset plate 15 may be welded to the top and bottom of the hitch engagement tube 12 and the bearing plate 13 providing reinforced support to the tube 12.

The hitch jack 10 may include a hand crank 14 and a base 20 configured to rest flat atop a surface. The base 20 may be, for example, a bottom swiveling foot 20A. In one exemplary embodiment, the hand crank 14 may be coupled to the jack housing tube 16 and configured to engage extension of the three tubes 16, 18 and 22. The swiveling foot 20A may be coupled to the drop leg tube 22 at the bottom of the trailer hitch jack 10.

The swiveling foot 20A may allow the trailer hitch jack 10 to move with the load keeping the swiveling foot 20A flat on the ground, preventing stress to the trailer hitch jack and unwanted falling off and slippage of the load. The swiveling foot 20A, may include a foot plate 24 with a foot swivel 26 that may be welded to it. A foot stub 23 may be hingably attached to the foot swivel 26 by a swivel pin 25. The swivel pin 25 may be press fitted through the foot swivel 26 and it may be loosely fitting through a swivel hole 27 that may be formed in a first end foot stub 23. A second end of foot stub 23 may be welded into a first end of the drop leg tube 22.

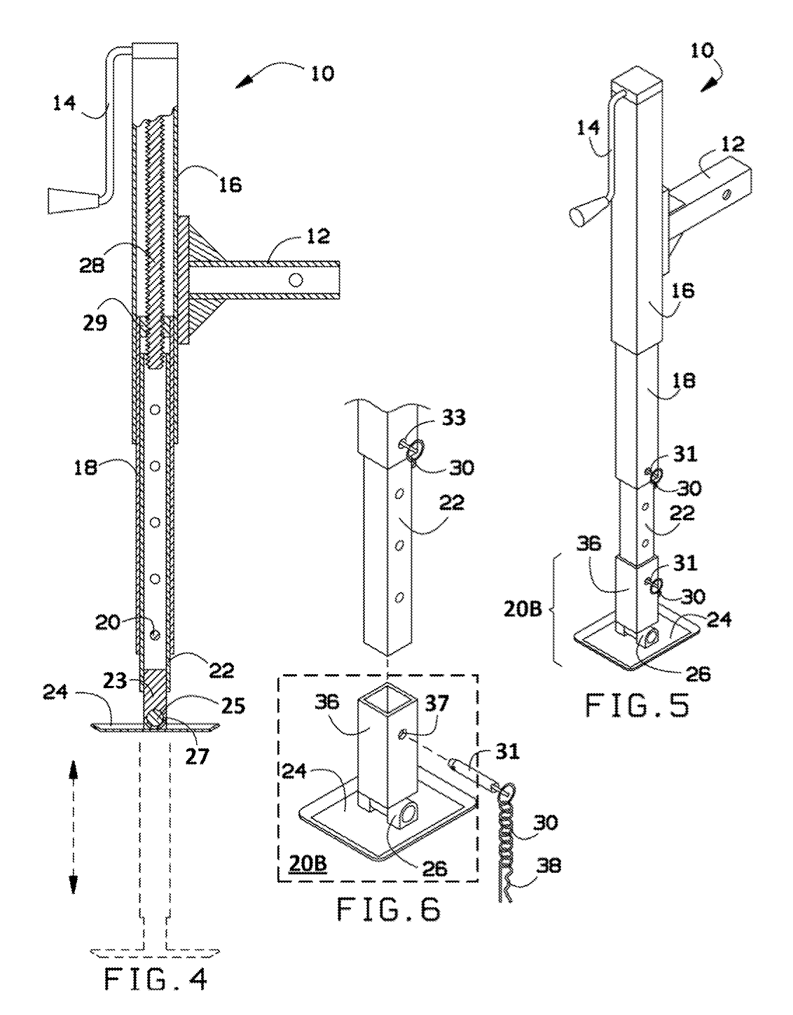

Referring to FIG. 4, a cross-sectional view of an exemplary assembly of the hitch jack 10 is shown taken along the line 4-4 of FIG. 2. The drop leg tube 22 may slidably fit into the extender tube 18. The drop leg tube 22 may be slid in or out of the first end of the extender tube 18 when the trailer hitch jack 10 is not loaded to adjust a baseline height of the trailer hitch jack 10. A second end of the extender tube 18 may be received by the jack housing tube 16. The jack housing tube 16 may include a trapezoidal threaded drive axle 28 that may be coupled to a corresponding threaded insert 29. The threaded insert 29 may be disposed at the second end of the extender tube 18. During operation, the hand crank 14 may rotate the drive axle 28. Depending on the direction of the rotation of the hand crank 14 the extender tube 18 may be either extended or retrieved. The bearing plate 13 may be about 2″ by 2″ and may be welded to the jack housing tube 16. The hitch engagement tube 12 may be plugged into a hitch receiver 32 of a vehicle 34 to allow the trailer hitch jack 10 to engage and mechanically communicate with the vehicle 34. The hitch engagement tube 12 may include a hitch securing hole 17, which may allow the insertion of a pin or other device through the hitch engagement tube 12 and the hitch receiver 32 to secure their engagement.

Referring to FIGS. 5-6, another exemplary embodiment of the hitch jack 10 is shown employing an alternate swiveling foot 20B. The swiveling foot 208 is similar to the swiveling foot 20A except that instead of being welded to the drop leg tube 22, the swiveling foot 20B may include a detachable configuration. For example; the swiveling foot 20B may have a foot adapter 36 that may be secured to the tube 22 by a securing pin 31. The foot adapter 36 may slide over the first end of the drop leg tube 22 and may be secured there by the securing pin 31. The securing pin 31 may penetrate through the foot adapter 36 and the drop leg tube 22 through a drop leg tube securing hole 33 and an adjustment hole 21 respectively. Once a desired length is set, the drop leg 22 may be secured to the extender tube 18 by the securing pin 31. The securing pin 31 may penetrate through the drop leg tube 22 and the extender tube 18 through the adjustment holes 21 and a drop leg tube securing holes 33 respectively. The securing pin 31 may have a retainer clip 38 attached to it with a securing pin chain 30. The retainer clip 38 may secure the securing pin 31 in its place once inserted.

The trailer hitch jack 10 may be used in daily farming, ranching, oil and gas exploration, construction and/or mining operations. The trailer hitch jack 10 with exchangeable swiveling foot 20B may easily be adapted for use in a wide variety of ground or road conditions.

It should be understood, of course, that the foregoing relates to exemplary embodiments of the invention and that modifications may be made without departing from the spirit and scope of the invention as set forth in the following claims.

What is claimed is:

1. A trailer hitch jack, comprising:
a jack housing tube;
a hitch engagement tube welded orthogonal to the jack housing tube, the hitch engagement tube configured to securely engage a hitch receiver of a vehicle;
an extender tube movably attached to the jack housing and configured to telescope in and out of the jack housing tube;
a drop leg tube having a first end, the drop leg movably attached to the extender tube and configured to telescope from the extender tube;
a base coupled to the first end of the drop leg tube; and
a hand crank coupled to jack housing tube being operable for moving the drop leg tube and raising the jack housing tube from the base.

2. The trailer hitch jack of claim 1, wherein the base includes.
a foot plate;
a foot swivel welded to the foot plate;
a foot stub having a first and second end, a swivel hole formed at the first end of the foot stub, the foot stub hingably attached to the foot swivel with a swivel pin, wherein the swivel pin is press fitted through the foot swivel and loosely fitting through the swivel hole.

3. The trailer hitch jack of claim 2, wherein the second end of the foot stub is permanently attached to the first end of the drop leg tube.

4. The trailer hitch jack of claim 2, wherein the second end of the foot stub is detachably coupled to the first end of the drop leg tube with a foot adapter.

5. The trailer hitch jack of claim 1, wherein the drop leg tube is movable to adjust and set a baseline height of the trailer hitch prior to having the hitch engagement tube engaging a hitch receiver.

6. The trailer hitch jack of claim 5, further comprising a bearing plate welded to the jack housing tube.

7. The trailer hitch jack of claim 1, further comprising a pair of gusset plates, the gusset plates welded to a top and a bottom of the hitch engagement tube and the bearing plate.

8. The trailer hitch jack of claim 1, further comprising a securing pin, the securing pin configured to penetrate through the drop leg tube and the extender tube.
